(19) United States
(12) Patent Application Publication
(10) Pub. No.: US 2005/0037154 A1
(43) Pub. Date: Feb. 17, 2005

(54) Method for forming thin film

(76) Inventors: Won Yong Koh, Daejeon-city (KR); Choon Soo Lee, Daejeon-city (KR)

Correspondence Address: MARGER JOHNSON & MCCOLLOM PC, 1030 SW MORRISON STREET, PORTLAND, OR, 97205, US

(21) Appl. No.: 10/495,157

(22) PCT Filed: Nov. 8, 2002
(86) PCT No.: PCT/KR02/02079

(30) Foreign Application Priority Data
Nov. 8, 2001 (KR) 2001-69597

(51) Int. Cl. H05H 1/24

(52) U.S. Cl. 427/576; 427/569; 427/578

(57) ABSTRACT

Method for forming a thin film at low temperature by using plasma pulses is disclosed. While a purge gas or a reactant purge gas activated by plasma is continuously supplied into a reactor, a source gas is supplied intermittently into the reactor during which period plasma is generated in the reactor so that the source gas and the purge gas activated by plasma reacts, so that a thin film is formed according to the method. Also, a method for forming a thin layer of film containing a plural of metallic elements, a method for forming a thin metallic film containing varied contents by amount of the metallic elements by using a supercycle T_{supercycle} comprising a combination of simple gas supply cycles T_{cycle}, . . . , and a method for forming a thin film containing continuously varying compositions of the constituent elements by using a supercycle T_{supercycle} comprising a combination of simple gas supply cycles T_{cycle}, . . . , are disclosed. The methods for forming thin films disclosed here allows to shorten the purge cycle duration even if the reactivity between the source gases is high, to reduce the contaminants caused by the gas remaining in the reactor, to form a thin film at low temperature even if the reactivity between the source gases is low, and also to increase the rate of thin film formation.

### CROSS-REFERENCE TO RELATED APPLICATION DATA

This application claims priority from Korean Application No. 2001-69597 filed Nov. 8, 2001; and PCT International Application No. PCT/KR02/02079 filed Nov. 8, 2002.

### BACKGROUND OF THE INVENTION

1. Field of the Invention

The present invention relates to a method of manufacturing a semiconductor, and particularly, to a method for forming a thin film at a low temperature using plasma pulses.

2. Description of the Related Art

During the process of constructing semiconductor integrated circuit elements, steps of forming thin films are performed several times. Commonly and frequently used methods are chemical vapor deposition (CVD) and physical vapor deposition (PVD). However, since the step coverage characteristics of a PVD method such as sputtering is poor, a PVD method may not be easily used for forming a thin film with a uniform thickness on a surface with deep trenches. On the other hand CVD method, where vaporized source gases react to each other on a heated substrate to form thin film on the substrate, has a good step coverage characteristics, thereby a CVD method can be used in the situations where a PVD method cannot be satisfactorily perform.

However, a uniform film may not be easily formed on an uneven surface with deep depressions such as contacts, via holes, or trenches, having an opening size less than one micrometer, even if a CVD method is used.

Meanwhile, an atomic layer deposition (ALD) method, in which the source gases for forming a thin film are time-divisionally and sequentially supplied and, thereby the source gases adsorbed on the substrate surface react each other to form a thin film, has a better step coverage characteristics than a CVD method, thereby a thin film with a uniform thickness can be formed even on an uneven surface with deep depressions. In a conventional ALD method, it is necessary to evacuate the existing first source gas in a reaction chamber prior to supplying a second source gas to remove the first source gas or to purge the first gas by using an inert gas, in preparation of eliminating the undesirable contaminant particles generated during the process of the first and the second source gases being mixed, otherwise. Furthermore, the second source gas has to be removed from the reactor before supplying the first source gas again. FIG. 1A is a timing diagram showing a process sequence for forming a thin film using a conventional ALD method. Referring to FIG. 1A, a process cycle for performing an ALD process comprises the steps of supplying a first source gas 10, feeding a purge gas 12, supplying a second source gas 14, and again feeding a purge gas 12. When a purge gas 12 is fed, the source gas remaining in the reactor is purged from the reactor, and alternatively, a vacuum pump is used in order to evacuate and remove the source gas remaining in the reactor. However, in a conventional ALD method, when the reactivity between the source gases 10 and 14 is very high, even a small amount of the source gas 10 or 14 remaining in the reactor may cause the formation of undesirable contaminant particles, therefore, a longer purge period may be necessary. On the other hand, when the reactivity between the source gases 10 and 14 is low, and thus the reaction between the source gases 10 and 14 requires a long time, the source gas supply duration may be increased, so that the over-all process time is increased.

On the other hand, when an evacuation process is performed using a vacuum pump after a source gas is supplied, the evacuation process may require a long time because an evacuation rate is decreased as the pressure in the reactor is reduced. Therefore, if a source gas remaining in the reactor is to be evacuated completely using a vacuum pump, it is difficult to increase a thin film growth rate per unit process step. On the other hand, if the evacuation time is reduced in order to shorten the process cycle, the source gas remaining in the reactor, is mixed with an incoming source gas and reacts with each other, thereby generating containments. In addition, by repeating the sequence of supply and evacuation cycles, the pressure in the reactor may fluctuating significantly.

An ALD method is disclosed in Korean Patent No. 0273473 and also International Patent Application No. PCT/KR00/00310, “Method of forming a thin film”, in which method, by activating the source gases by using plasma pulses in synchronization with the gas supply durations, even at a low temperature, it makes a surface chemical reaction possible, the contaminant particles in the reactor is reduced, and also the source gas supply cycle time is reduced. FIG. 1B is an illustrative drawing for the process of such an ALD method. Referring to FIG. 1B, a gas supply cycle, during which a source gas 20 is supplied, the reactor is purged using a purge gas 22, a second source gas activated with plasma 24 is supplied, is repeated. Here, since activation in the reactor stops when the plasma is ceased, a second purge process cycle may be eliminated compared to the ALD method in FIG. 1A where no plasma is used. However, the method of Korean Patent No. 0273473 requires manipulating a plurality of valves to change the various gases supplied to the reactor, and the gas supply system for such manipulation of valves becomes complex in an ALD apparatus in which only one gas, either source gas or a purge gas, is supplied mutually exclusively. In particular, when a vaporization apparatus converting a source material with low vapor pressure into a gaseous state is used and a high temperature for such source gas is maintained in order to avoid any condensation, it is difficult to control the flow of the source gas with low vapor pressure coming from such vaporization apparatus by adjusting the valves. It is possible that the source gas with low vapor pressure is readily condensed to become either a liquid state or a solid state inside the valve with a complex gas passage way, thereby such condensation interferes with a smooth operation of a valve.

### SUMMARY OF THE INVENTION

The objects of the present invention are to provide a method of forming thin films that does not necessitate a prolonged duration of purge process even if the reactivity between the source gases is higher, that reduces the contaminant particles generated in the reaction chamber, that even if the reactivity between source gases is lower, formation of thin films at low temperature becomes possible, and also that increases the thin film deposition rate per unit process cycle.

In order to achieve the afore-described objectives, the present invention through a series of embodiments to follow the steps of (a) supplying a first source gas into a reactor for forming a thin film, (b) after cessation of supply of the first source gas, purging the first source gas remaining in the reactor, (c) supplying a second source gas into the reactor and plasma being generated by applying an RF power while supplying a second source gas into the reactor, in order to activate the second source gas, (d) ceasing plasma generation and also ceasing the supply of the second source gas, for forming a thin film by feeding a purge gas continuously during the steps of (a) through (d) described above.

Also, according to another aspect of the present invention, a method of forming a thin film by supplying the purge gas continuously even during the process of purging the activated second source gas, further comprises a step of purging the activated second source gas remaining in the reactor after the step (d) above.

Also, according to the present invention, a thin film is formed by replacing the step (d) above with the step of switching off the RF power first and then after a specified period of time, stopping the supply of the second source gas, and additionally, by feeding the purge gas continuously even during the supply period of the second source gas after the RF power is switched off.

According to another aspect of the present invention, the method for forming a thin film further comprises after the step (d) additional steps of, above, (e) supplying a third source gas into the reactor, (f) purging the third source gas remaining in the reactor after discontinuing supply of the third source gas, (g) activating the second source gas by generating plasma in the reactor while the second source gas is being supplied into the reactor during the step of supplying the second source gas, and finally (h) stopping the step of supplying the source gas as well as stopping the step of supplying power, and furthermore during the entire processes of the steps from the (e) through (h) the purge gas is continuously supplied.

Also, according to the present invention, a thin film containing more constituent elements contained in the first source gas than the thin film obtained by repeating the processes of the steps from (a) through (h), by repeating the steps from (a) through (h) m times and also by repeating the process of the steps from (a) through (d) n times, where the m and the n are positive integers greater than 1, and also m is greater them n.

Also, according to the present invention, a thin film with a continuously and gradually varying composition is formed by not fixing the valves of the m and the n, but setting them to 0 (zero) or positive integers in forming a thin film by repeating the process of the steps from (a) through (h) m tines, and also repeating the process of the steps form (a) through (d) n times.

According to another aspect of the present invention, a thin film is formed by feeding the purge gas continuously even during the process of the step of supplying the second source gas after the RF power is switched off, when the step (d) is replaced with the step of the RF power being switched off first, and then, after a given period of time, stopping supply of the second source gas, and also the step (h) is replaced with the step of the RF power being switcheel off first, and then, after a given period of time, stopping supply of the second source gas.

Also, according to yet another aspect of the present invention, a thin film is formed by feeding the purge gas continuously even during the process of the step of purging the activated second source gas, after the step (d) but before the step (f), further comprises a step of purging the second source gas activated and remained in the reactor, and also, after the step (h), further comprises a step of purging the second source gas activated and remained in the reactor.

According to yet another aspect of the present invention following another embodiment, a method of forming a thin film by feeding a reactive purge gas continuously to the reactor while the following steps of processing are being executed, which steps comprise (a) a step of supplying a source gas into the reactor, (b) a step of stopping the supply of the source gas, and purging the source gas remaining in the reactor, (c) a step of activating the reactant purge gas by applying the RF power, (d) a step of switching off the RF power.

Also, according to another aspect of the present invention, a method of forming a thin film by supplying the reactant purge gas continuously, even during the process of purging the activated reactant purge gas, further comprises a step of, after the step (d) above, purging the activated reactant purge gas remaining in the reactor.

According to another aspect of the present invention, a method of forming a thin film by supplying the reactive purge gas continuously even during the process of the steps (e) through (h), further comprises after the step (d) above, the steps of (e) supplying the second source gas into the reactor, (f) stopping the supply of the second source gas and purging the second source gas remaining in the reactor, (g) activating the reactive purge gas by applying RF power, and (h) switching off the RF power.

Also, according to another aspect of the present invention, a method of forming a thin film by supplying the reactive gas continuously even during the process of the step of purging the activated reactant purge gas, further comprises, a step of purging the activated reactant purge gas remaining in the reactor after the step (d), and also, a step of purging the activated reactant purge gas remaining in the reactor after the step (h).

### BRIEF DESCRIPTION OF THE DRAWINGS

The above and other features and advantages of the present invention will become more apparent by describing in detail exemplary embodiments thereof with reference to the attached drawings in which:

FIGS. 1A and 1B are timing diagrams illustrating the timing sequences of a conventional atomic layer deposition (ALD) method;

FIGS. 2A through 2C are the drawings illustrating the timing sequences of the first embodiment for a method of thin film formation according to the present invention;

FIGS. 2D and 2E are two schematic drawings illustrating the source gas supply systems in reference to FIGS. 2A through 2C;

FIGS. 3A and 3B are the drawings illustrating the timing sequences of the second embodiment for a method of thin film formation according to the present invention;

FIG. 3C is a schematic drawing illustrating a source gas supply system in reference to FIGS. 3A and 3B;

FIGS. 4A through 4C are the drawings illustrating the timing sequences of the third embodiment for a method of thin film formation according to the present invention;

FIGS. 4D and 4E are two schematic drawings illustrating two source gas supply systems in reference to FIGS. 4D and 4E;

FIGS. 5A and 5B are two drawings illustrating the timing sequences of the fourth embodiment for a method of thin film formation according to the present invention;

FIG. 5C is a schematic drawing illustrating a source gas supply system in reference to FIGS. 5A and 5B;

FIGS. 6A and 6B are the drawings illustrating the timing sequences of the fifth embodiment for a method of thin film formation according to the present invention; and

FIGS. 7A and 7B are two drawings illustrating the timing sequences of the sixth embodiment for a method of thin film formation according to the present invention.

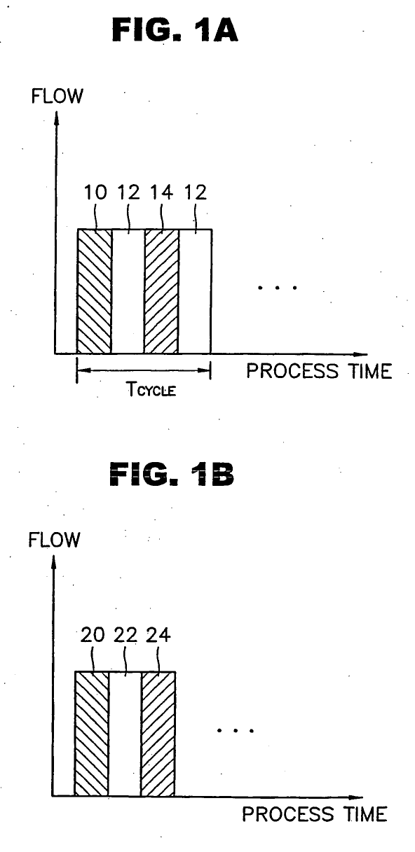

### DETAILED DESCRIPTION OF THE INVENTION

The present invention is described in detail by presenting seven embodiments in the following in reference to the accompanying drawings, in which same item numbers indicate identical process elements taking place at different times.

Embodiment 1

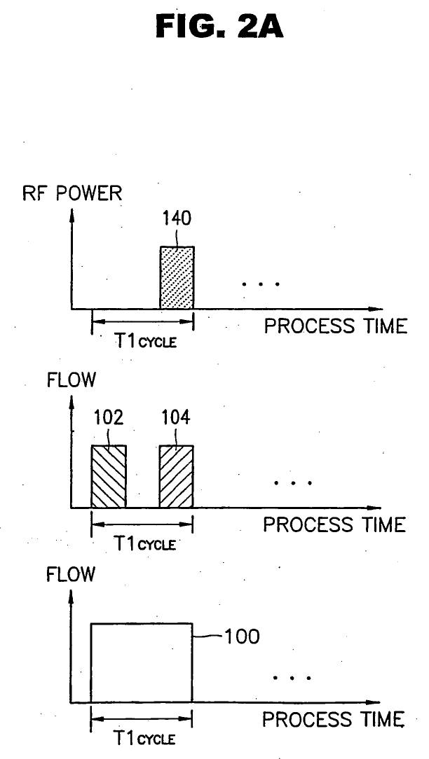

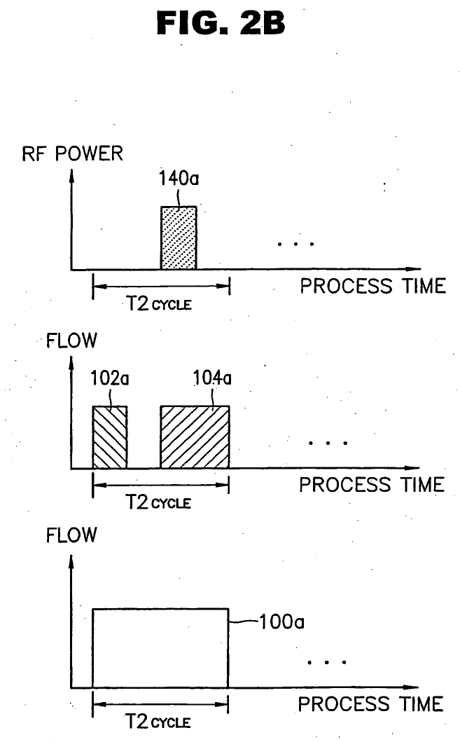

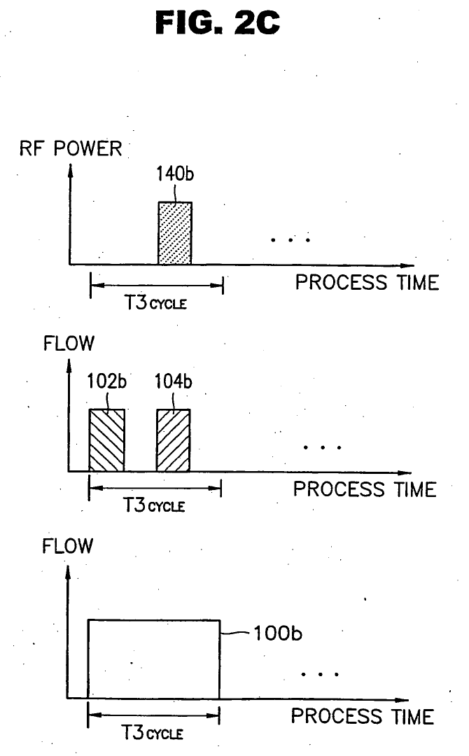

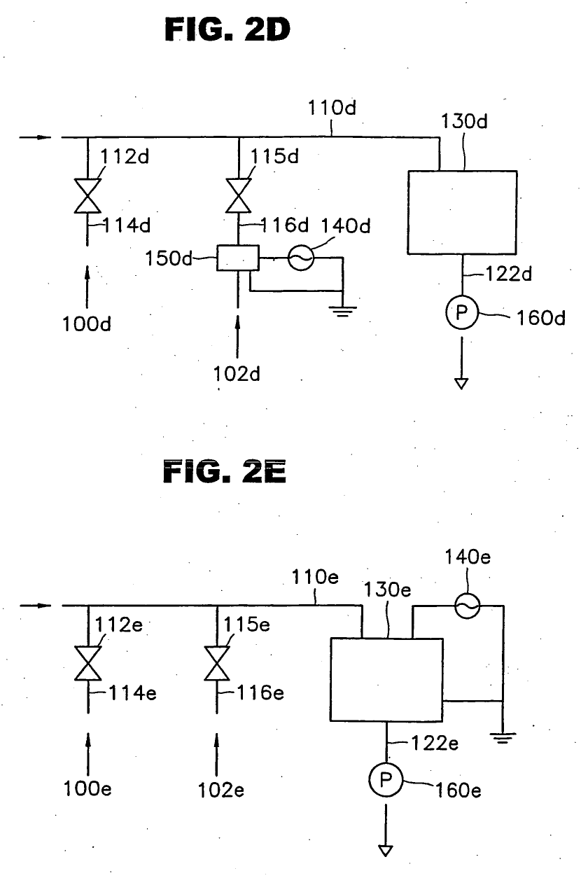

FIGS. 2A through 2C are the drawings illustrating timing sequences of the first embodiment for a method of thin film formation according to the present invention, and FIGS. 2D and 2E are two schematic drawings illustrating two source gas supply systems in reference to FIGS. 2A through 2C.

Referring to FIG. 2A, during the gas supply cycle T_{1cycle}, a purge gas 100 is continuously supplied into a reactor (not shown). Inside said reactor, where said chemical reaction for depositing a thin film takes place, a substrate targeted for depositing a thin film on it is loaded (not shown). As a purge gas 100, an inert gas such as Helium (He), Argon (Ar), or Nitrogen (N₂) may be used. However, a gas containing the elements included in the thin film to be formed may be used as a purge gas 100 as long as such potentially usable purge gas 100 does not readily react with the source gases 102, 104. First, by supplying a first source gas 102, a first source gas 102 is adsorbed onto the surface of said substrate. Said first source gas 102 contains the elements needed for forming a desired thin film, and said first gas does not react with said purge gas 100. When the supply of said first source gas 102 is stopped, said first source gas remaining in said reactor not adsorbed onto the surface of said substrate is exhausted to outside of said reactor by said purge gas 100 being continuously supplied into said reactor. Next, a second source gas 104 is supplied into said reactor, and during the supply cycle of said second source gas 104, an RF power 140 is applied to generate plasma. Said RF power 140 may be applied in synchronous with said second source gas 104, or said RF power 140 may be applied after a given time period since the start of the supply of said second source gas 104. Ions or radicals or other radical species of said second source gas 104 activated by said RF power 140 form a thin film by reacting with said first source gas 102 adsorbed onto the surface of said substrate. Said second source gas 104 containing the elements of a thin film to be formed, does not react with said purge gas 100, and said activated (by plasma) second source gas 104 reacts with said first source gas 102, but said second source gas 104, if it is not activated by plasma, does not react with said first source gas 102.

Next, said RF power 140 is switched off and also the supply of said second source gas 104 is stopped. When said RF power 140 is disconnected, the reactivity of said second source gas 104 disappears within several milliseconds, therefore even if said first source gas 102 is supplied immediately afterward, no contaminant particles are possibly generated. FIG. 2A shows a timing diagram showing that said first source gas 102 is supplied immediately after the supply of said second source gas 104, activated by said RF power, is stopped. In case of FIG. 2A, both the supply of said RF power 140 and also the supply of said second source gas 104 are stopped simultaneously. Instead, in order to completely stop the generation of undesirable particles by preventing the contact of the activated second source gas 104a with the first source gas 102a in a vapor state, either the supply of the second source gas 104a may be stopped from several to several hundred milliseconds after the supply of said RF power 140a is ceased, as illustrated in FIG. 2B, or as shown in FIG. 2C, after stopping the supply of said RF power 140b and also the supply of the second source gas 104b, the step of supplying a purge gas 100b for several through several hundred milliseconds may be added before the step of supplying the first source gas 102b. In this way, a thin film to a desired thickness is formed by repeating the cycle of supplying said first source gas 102, 102a, 102b and supplying said second source gas 104, 104a, 104b alternately and sequentially, while said purge gas 100, 100a, 100b is supplied continuously during the gas supply cycles T_{1cycle}, T_{2cycle}, T_{3cycle}.

In order to minimize the dead space within an apparatus where a gas does not flow, a valve having gas supply tubes and on-off mechanisms as one unit may be used for supplying source gases. FIG. 2D illustrates an apparatus for supplying plasma-activated second source gas 104, 104a, 104b into a reactor 130 through a valve 115 described above. Referring to FIG. 2D, the purge gases 100, 100a, 100b is supplied to said reactor 130 through a main gas supply tube 110. A first source gas 102, 102a, 102b is supplied into a main gas supply tube 110 through a first gas supply tube 114 and also through a valve 112, and then said first source gas 102, 102a, 102b fed through said main gas supply tube 110, is supplied into a reactor 130. Said source gas 104, 104a, 104b plasma-activated by the plasma generated by an RF power in the plasma generator 150, is fed into a main gas supply tube through a second gas supply tube 116 and through a valve 115, and then said second source gas 104, 104a, 104b fed into a reactor 130 through said main gas supply tube 110, whereby two valves 112, 115 are inserted into said main supply tube without a T connector. The gas supplied into a reactor 130 is exhausted to the outside said reactor 130 through said gas outlet tube 122. Up to now and in the descriptions to follow, “exhaust” is meant to either “evacuated”, “purged” or “discharge”. On the other hand, the gas exhaust tube 122 is connected to a vacuum pump 160, and the gas inside the reactor 130 is exhausted to the outside said reactor more efficiently by said vacuum pump 160.

FIG. 2E illustrates an apparatus for activating a second source gas 104, 104a, 104b in a reactor 130 generating a plasma in said reactor by feeding said inactivated second source gas 104, 104a, 104b into said reactor 130 through said valve 115, and also by applying RF power 140 in the reactor 130 while said second source gas 104, 104a, 104b is being supplied. The explanation of FIG. 2E is not repeated here because the apparatus in FIG. 2E is almost identical to that in FIG. 2D with the exception that an RF power is connected to said reactor 130 in such a way that a plasma is generated in the reactor 130, when the source gas supply apparatus in FIG. 2E is compared with the source gas supply system in FIG. 2D.

On the other hand, in order to use a source material in a liquid state at atmospheric temperature and pressure or a source material in a liquid state obtained by desolving a source material in a liquid or solid state at atmospheric temperature and presume using a solvent, a vaporization apparatus (not shown) that vaporizes such liquid or solid state source material may be used in such a way that said vaporized source gas is supplied to a reactor 130 without such supply being interrupted through said gas supply tube. An apparatus suitable for this purpose is disclosed in International Patent Application No. PCT/KR00/01331, “Method of vaporizing liquid sources and apparatus therefore”. If such an apparatus is used, no valve between said vaporizer and said reactor 130 is needed, and there is no problem in maintaining the gas supply tube between said vaporizer and said reactor 130 at a high temperature. For example, said vaporizer can be used by connecting said vaporizer and said first gas supply tube 114 without using said valve 112 shown in FIG. 2E.

Experiment 1

Following the method for forming a thin film according to Embodiment 1 of the present invention above, a tantalum oxide film was formed. Supply of a liquid source material is controlled by connecting afore-described vaporizer in FIG. 2E to the first gas supply tube 114, and a liquid source material pentaethyloxidetantalum [Ta(OC₂H₅)₅] is supplied through the first gas supply tube 114. Using a source material supply system including an apparatus that controls the supply of a source gas supply of pentaethyloxidetantalum, a tantalum oxide film of thickness of 75 nm was formed by using the following steps and under the conditions described below. The pressure in the reactor is maintained at 3 Torr and the temperature of a substrate is kept at 300° C., and while 300 sccm of argon(Ar) gas is continuously bed, 10 μm of pentaethyloxidetantalum is supplied in 3 ms. After 0.997 second is lapsed, a valve 115 is opened and 100 sccm of oxygen(O₂) gas was supplid through the second gas supply tube 116, after which an RF power of 180 watts at the frequency of 13.56 MHz is applied. After 1 second, said valve is closed and at the same said RF power 140 is switched off, and after 0.5 second is elapsed the supply of a pentaethyloxide as a source gas is started. Such 3 second gas supply cycle is repeated 100 times to form a tantalum oxide film.

Embodiment 2

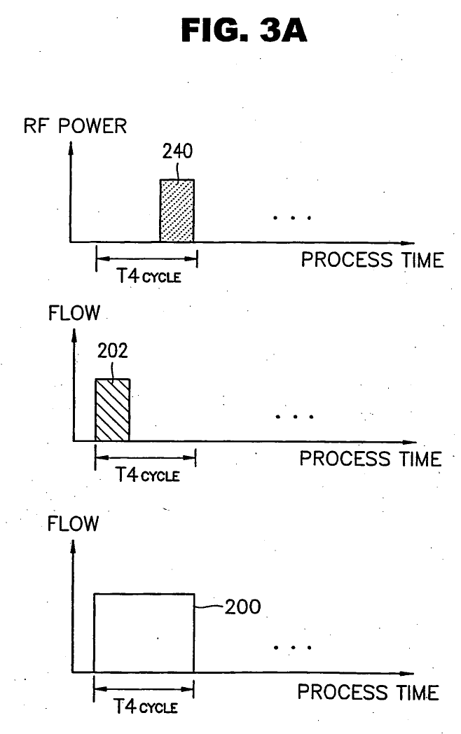

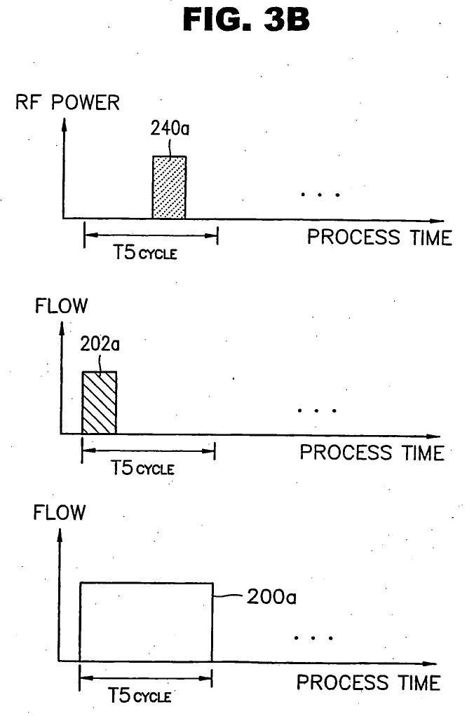

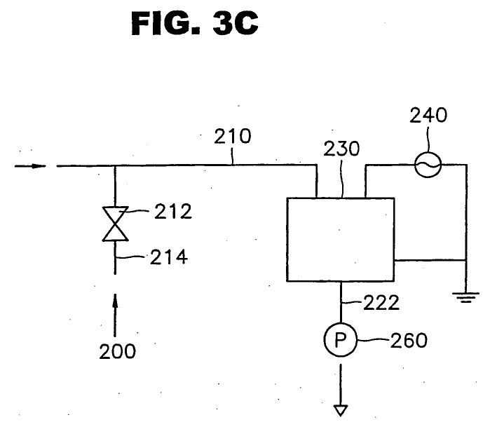

Gas supply cycles can be arranged as shown in FIGS. 3A and 3B for forming a thin film when a purge gas contains the constituent element of the thin film to be formed, and also a source gas does not react with said purge gas, but said source gas reacts with a reactant purge gas if activated by plasma.

Referring to FIG. 3A, during the gas supply cycle T4_{cycle}, said reactant purge 200, is continuously supplied to a reactor (not shown). A substrate on which a thin film is to be deposited is loaded in said reactor (not shown). A reactant purge gas 200 containing the constituent element of thin film to be formed and not reacting with a source gas 202, but reacting with said source gas, when activated by plasma, may be used for forming a thin film desired. Specifically, a source gas 202 is supplied to said substrate so that said source gas 202 is adsorbed on the surface of said substrate. Said source gas 202 contains the constituent element needed for forming a thin film, and said source gas 202 does not namely react with a reactant purge gas 200. Supply of said source gas 202 into a reactor (not shown) is stopped, and said source gas 202 not adsorbed on said substrate but remaining in said reactor is exhausted out from said reactor by supplying said reactant purge gas 200 continuously into said reactor. After said source gas 202 is exhausted to the outside of said reactor by said reactant purge gas 200, an RF power 240 is applied. Said reactant purge gas 200 activated by plasma reacts with said source gas 202 adsorbed on the surface of said substrate, thereby a thin film is formed.

Thereafter, said RF power 240 is switched off. When said RF power is switched off, said activated reactant purge gas 200 looses its reactivity within several milliseconds, and then even if a source gas 202 is supplied, undesirable particles are not likely to be generatated.

In FIG. 3A, said source gas 202 is supplied immediately after said RF power is switched off, but before the step of supplying said source gas 202a, a step of supplying said reactant purge gas 200a for several up to several hundred milliseconds after said RF power 240a is turned off as shown in FIG. 3B so that the activating species disappear, and this, in turn, completely prevents undesirable contaminant particles from being generated by blocking the contact between said activated reactant purge gas 200a and said source gas 202a in a gaseous state. In this way, a thin film is formed to a desired thickness by repeating the process cycle, T4_{cycle} or T5_{cycle of supplying said reactant purge gas 200 or 200}a is continuously supplied during the (purge) gas supply cycles, T4_{cycle} or T5_{cycle}, and at the same time said source gas 202, 202a is sequentially and intermittently, and also, while said reactant purge gas 200, 200a is being supplied, and RF power 240 or 240a is applied sequentially and intermittently during the process cycles T4_{cycle} or T5_{cycle}.

As an example, oxygen(O₂) gas which has weak reactivity at low temperature is used as a reactant purge gas 200, 200a, and while said reactant purge gas 200, 200a is being supplied, an oxygen plasma is generated in a reactor by applying an RF power 240, 240a to said reactor to form a thin film. More specifically, in case of trimethylaluminum [(CH₃)₃Al], which reacts with oxygen(O₂) under atmospheric pressure, is used as a source gas 202, 202a, said oxygen(O₂) and said source gas do not normally react with each other at low pressure and at a temperature no lighter than 300° C., oxygen(O₂) gas can be used as a reactant purge gas 200, 200a at low pressure and at a temperature no higher than 300° C., thereby an aluminum oxide film [Al₂O₃] is formed according to Embodiment 2 disclosed here.

As a second example, a metallic thin film can be formed by using hydrogen (H₂) gas, which has weak reactivity at low temperature, as a reactant purge gas 200, 200a, and thereby by generating hydrogen plasma in a reactor by applying an RF power 240, 240a to said reactor while said reactant purge gas 200, 200a is supplied. To be more specific, a thin film of titanium (Tᵢ) is formed by using titanium chloride (TᵢCl₄) as a source gas 202, 202a, and also by using hydrogen (H₂) gas as a reactant purge gas 200, 200a.

As another example yet, a thin film of nitride can be formed by using nitrogen (N₂) gas or a gas mixture of nitrogen and hydrogen (N₂+H₂), which do not react with most of the metals at a temperature lower than 400° C., as a reactant purge gas 200, 200a, and an RF power 240, 240a is applied to a reactor while said reactant purge gas 200, 200a is being supplied.

The thin films that can be formed by using the atomic layer deposition (ALD) method are listed in Table 1.

Instead of using pure hydrogen(H₂), oxygen(O₂) or nitrogen(N₂) gases, such gases mixed with inert gases such as argon(Ar) and helium(He) can be used as well. In order to potentially minimize the dead spaces, where a gas is “trapped” and does not flow, a valve made of a gas supply tube and a gas on-off mechanism as one bodily unit may be used for structuring a gas supply system suitable for such purposes of reducing said dead spaces. FIG. 3C illustrates a process gas distribution system for activating a reactant purge gas 200, 200a by generating plasma inside a reactor 230 in which an RF power 240 is applied while a non-activated reactant purge gas is being supplied. Referring to FIG. 3C, said reactant purge gas 200, 200a is supplied to said reactor through a main gas supply tube 210. A source gas 202, 202a is fed into said main gas supply tube 210 through the first gas supply tube 214 and also a valve 212, and then is supplied into said reactor 230, to which RF power 240 or a plasma generator for generating plasma is connected. Said valve 212 is connected to said main gas supply tube 212 directly without using a T connector. Said gas supplied to said reactor is exhausted to the outside of said reactor 230.

TABLE 1

| Source gas | Reactive purge gas | Thin film to be formed |
|---|---|---|
| (CH₃)₂Zn | O₂ | ZnO |
| (CH₃)₃Al | O₂ | Al₂O₃ |
| Ta(OC₂H₅)₅ | O₂ | Ta₂O₅ |
| Zr(O-t-C₄H₉)₄ | O₂ | ZrO₂ |
| Hf(O-t-C₄H₉)₄ | O₂ | HfO₂ |
| Ti(O-l-C₃H₇)₄ | O₂ | TiO₂ |
| Sr[Ta(O-l-C₃H₇)₆]₂ | O₂ | SrTa₂O₆ |
| Sr(thd)₂ | O₂ | SrO |
| Ba(thd)₂ | O₂ | BaO |
| Bi(thd)₃ | O₂ | Bi₂O₃ |
| Pb(thd)₂ | O₂ | PbO |
| TiCl₄ | H₂ | Ti |
| TaCl₅ | H₂ | Ta |
| (CH₃)₃Al | H₂ | Al |
| TiCl₄ | N₂ + H₂ | TiN |
| Ti[N(CH₃)₂]₄ | N₂ + H₂ | TiN |

A gas outlet tube 222 connects said reactor 230 and a vacuum pump 260, and the gas in said reactor 230 is more efficiently exhausted to outside by said vacuum pump 260.

Experiment 2-A

In accordance with the method for forming a thin film in Embodiment 2 described above, an aluminum oxide [Al₂O₃] film was formed. Referring to FIG. 3C, in a source gas supply container 200 containing trimethylaluminum [(CH₃)₃Al] is connect to a main gas supply tube 210 through a first gas supply tube 214 and a valve 212 in such a way that the supply of the source gas trimethylaluminum [(CH₃)₃Al] is controlled. The pressure of said reactor 230 is maintained at 3Torr and the temperature of said substrate (not shown) inside said reactor 230 is kept at 200° C., and also 200 sccm of argon(Ar) gas and 100 sccm of oxygen(O₂) gas are supplied to said reactor 230 continuously through said main supply tube 210, and at the same time trimethylaluminum [(CH₃)₃Al] source gas is supplied to said reactor for 0.2 second, and 0.2 second later a 13.56 MHz of RF power 240 at the level of 180 watts is applied for 0.6 second and then the RF power 240 is turned off, and then, again, trimethylaluminum [(CH₃)₃Al] source gas is supplied for the next cycle. Here, the total process time is 1 second, and this complete cycle is repeated 100 times to obtain an aluminum oxide [Al₂O₃] film of 15 nm in thickness.

### EXAMPLE 2-B

In accordance with the method for forming a thin film in Embodiment 2 described above, a titanium(Tᵢ) film was formed. Referring to FIG. 3C, a source gas container 200 containing titaniumchloride [TiCl₄] gas heated at 50° C. is connected to said reactor 230 through a first gas supply tube 214 and a valve 212 in such a way that the supply of said titaniumchloride [TiCl₄] gas is controlled. The pressure of said reactor 230 is maintained at 3 Torr and the temperature of said substrate (not shown) inside said reactor 230 is also maintained at 380° C., and also 330 sccm of argon(Ar) gas and 100 sccm of hydrogen(H₂) gas are supplied to said reactor 230 continuously through said main supply tube 210, and at the same time, said titaniumchloride [TiCl₄] source gas is supplied for 0.2 second, and 2 seconds later, an RF power 240 at the frequency of 13.56 MHz and at the level of 200 watts is applied for 2 seconds, and the RF power 240 is turned off, and then, after 1.8 seconds said titaniumchloride [TiCl₄] gas is again supplied for the next cycle. Here, the total process time is 6 seconds, and this 6 seconds of complete cycle is repeated to form a thin film of titanium [Ti].

Experiment 2-C

In accordance with the method of forming a thin film in Embodiment 2 described above, a thin film of titanium nitride is formed. Referring to FIG. 3C, a source gas container 200 containing titaniumchloride [TiCl₄] gas heated at 50° C. is connected to said reactor 230 through a first gas supply tube 214 and a valve 212 in such a way that the supply of said titaniumchloride [TiCl₄] gas is controlled. The pressure of said reactor 230 is maintained at 3 Torr, and the temperature of said substrate (not shown) inside said reactor 230 is also maintained at 350° C., and also 300 sccm of argon (Ar) gas, 100 sccm of hydrogen (H₂) and 60 sccm of nitrogen (N₂) gases are supplied to said reactor 230 continuously through the main supply tube 210, and at the same time, said titaniumchloride [TiCl₄] gas is supplied for 0.2 seconds, and 0.6 second later, an RF power 240 at the frequency of 13.56 MHz and at the power level of 150 watts is applied for 0.8 second, and then said RF power 240 is turned off, and then after 0.4 second, said source gas of titanium chloride [TiCl₄] gas is again supplied for the next cycle. Here, the total process time is 2 seconds, and this 2 seconds of complete cycle is repeated for 600 times to form a thin titanium nitride [TiN] film of 24 nm in thickness.

Embodiment 3

Various thin films containing metallic elements'such as SrTiO₃ or SrBi₂Ta₂O₅ can be formed by using metallic source gases. In case that a thin film is formed using a mixture of several different metallic source gases, the process gas supply systems as shown in FIGS. 2A, 2B, 2C, 3A or 3B may be utilized. When it is difficult to use said mixture of source gases for the reason of interactions between various metallic source materials, a process gas supply system and the corresponding timing sequences structured by combining the gas supply systems for each metallic source as shown in FIGS. 2A, 2B, and 2C, or by combining the gas supply systems for each metallic source as shown in FIGS. 3A and 3B, may be used.

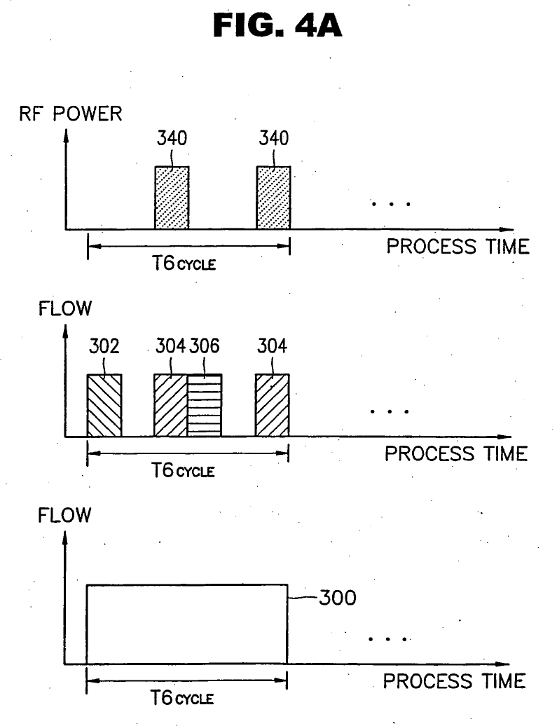

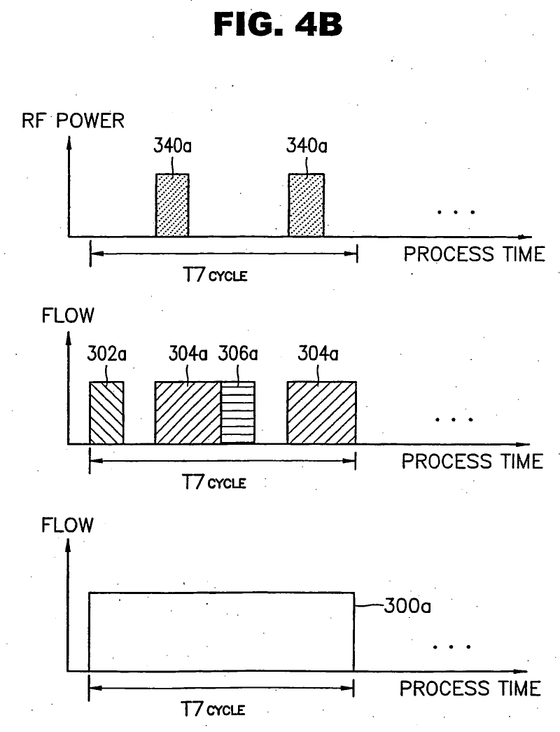

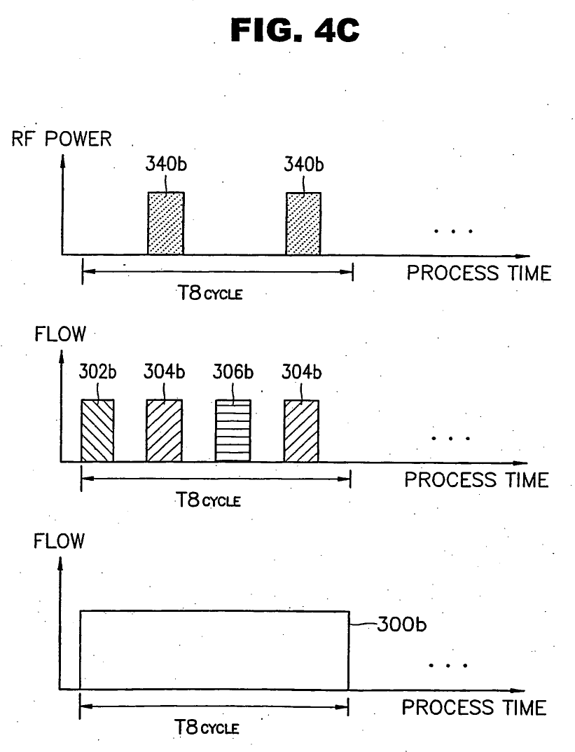

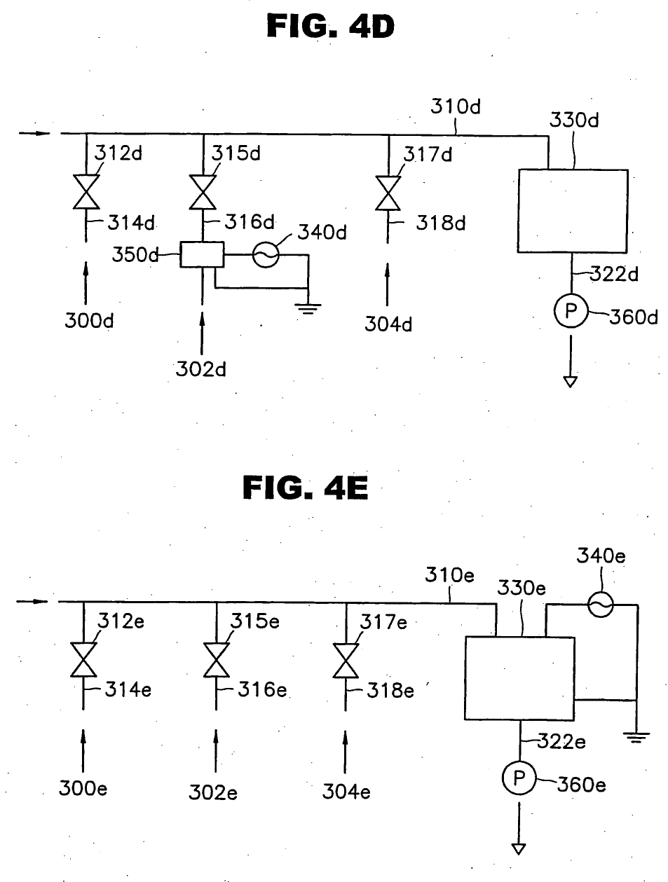

The timing diagrams shown in FIGS. 4A, 4B and 4C are the extended versions of the timing diagrams in FIGS. 2A, 2B and 2C, respectively, and shown in FIGS. 4A, 4B and 4C are illustrative process timings for forming metallic thin films using two different metallic sources supplied by two separate source gas supply systems as shown in FIGS. 4D and 4E, respectively.

For example, in FIG. 4D the first source gas 370 contains the first metallic element, the second source gas 372 is oxygen (O₂) or nitrogen (N₂) gas, and the third source gas 374 contains the second metallic element, thereby two different metallic source gases 370, 374 are supplied to said reactor 330, and a thin film containing two different metallic materials is formed on said substrate (not shown) in said reactor 330. Similarly, a thin film containing three different metallic materials can be formed on said substrate (not shown) in said reactor 330 by extending the gas supply system as shown in FIG. 4D by adding a third source gas supply reservoir.

Referring to FIG. 4A, during the gas supply cycle T6_{cycle}, a purge gas 300 is continuously supplied into a reactor (not shown) loaded with a substrate. The first source gas 302 is supplied to said reactor (not shown) so that a part of the first source gas 302 is adsorbed onto the surface of said substrate (not shown), then the supply of the first source gas 302 is stopped, and the remaining source gas in said reactor (not shown) is purged to the outside said reactor (not shown) by feeding said purge gas 300. The first source gas 302, when not activated, does not react with said purge gas 300, wherein said source gas 302 contains the metallic constituent element of a thin film to be formed. Next, the second source gas 304 is supplied into said reactor (not shown). While said second source gas 302 is being supplied, an RF power 340 is applied as shown in FIG. 4D.

Said RF power 340 may be applied at the same time of supply of the second source gas 304 or said RF power may be applied after supplying the second source gas 304 for a pre-determined amout of time. Said second source gas 304 activated by plasma 340 reacts with said first source gas 302 adsorbed onto the substrate and forms a thin film. Next, the RF power 340 is turned off and then supply of said second source gas 304 is stopped. The second source gas 304 contains a constituent element of the thin film to be formed, and does not react with the purge gas 300 and also does not react with the first source gas 203 when the first source gas 302 is not activated. Successively, the third source gas 306 is supplied so that the third source gas 306 is adsorbed onto the surface of said substrate (not shown) in said reactor (not shown). The supply of third source gas 306 is stopped and the unabsorbed third source gas 306 remaining in the reactor (not shown) is purged by feeding said purge gas 300 into said reactor and then eventually to the outside of said reactor. Here, the third source gas 306 contains a constituent element of the thin film to be formed, and does not react with said purge gas 300 and also does not react with the second source gas 304, when not activated. Next, the second source gas 304 is supplied into said reactor during which plasma is generated in the reactor by turning on the RF power 340 in FIG. 4E. The second source gas 304 activated by plasma 340 reacts with the third source gas 306 adsorbed onto the surface of said substrate to form a thin film. The RF power 340 is turned off to cut off the plasma inside the reactor followed by the stoppage of the supply of the second source gas 304. In FIG. 4A, the third source gas 306 or the first source gas 302 is supplied into said reactor (not shown) immediately after the second source gas 304 is activated by plasma in the reactor. However, as shown in FIG. 4B, after the plasma 340a is cut off, several and up to several hundred milliseconds (ms) later, supply of the second source gas 304a is stopped, or as shown in FIG. 4C, after the activation of the second source gas 304b is stopped by turning the plasma off, a purge gas 300b may be supplied into the reactor for several and up to several hundred milliseconds(ms) so that the radicals or radical species would disappear, before the first source gas 302b and the third source gas 306b is supplied into the reactor.

As afore-described, referring to FIGS. 4A, 4B and 4C, while a purge gas 300, 300a, 300b is continuously supplied during the gas supply periods T6_{cycle}, T7_{cycle}, T8_{cycle}, at the same time, the first source gas 302, 302a, 302b, the second source gas 304, 304a, 304b, the third source gas 306, 306a, 306b and the second source gas 304, 304a, 304b are supplied intermittently as well as alternately, and also these gas supply cycles T6_{cycle}, T7_{cycle}, T8_{cycle}, are repeated so that a thin film in desired thickness is formed.

FIGS. 4D and 4E are schematic drawings of source gas supply systems, wherein two different metallic source gases are supplied in order to form a thin film that contains those two metallic elements contained in those two metallic source gases. Comparing the source gas supply system shown in FIGS. 4D and 4E with the source gas supply system shown in FIGS. 2D and 2E, they are the same with the exception that the source gas supply system in FIGS. 4D and 4E additionally contains a third source gas supply tube 318 and a value 317 that control the supply of the third source gas 306, 306a, 306b, thereby the functional description of the source gas supply system is not given here.

Embodiment 4

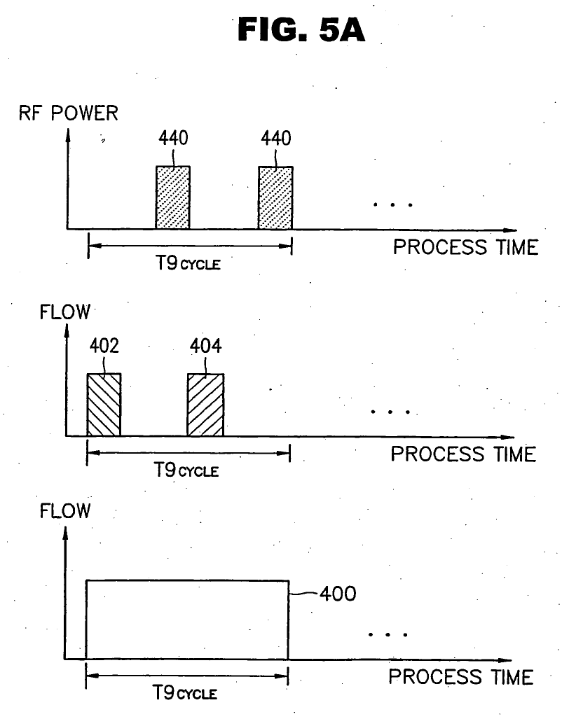

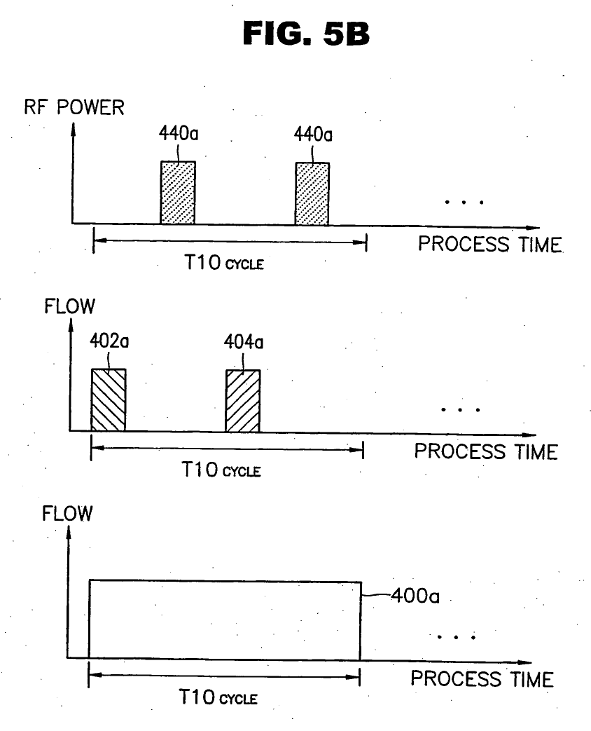

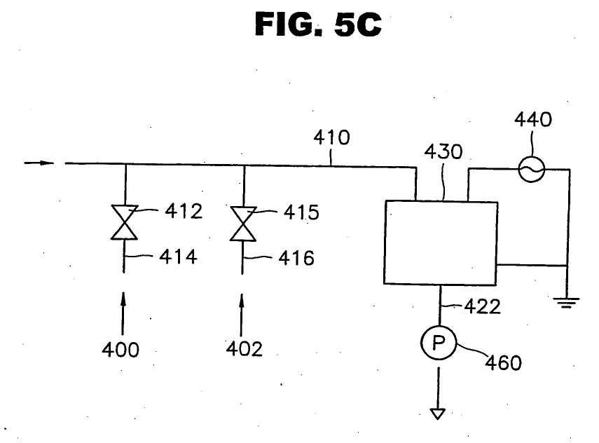

FIGS. 5A and 5B are the schematic diagrams illustrating the process timing sequences which are the extentions of the method for forming a thin film using the timing diagrams in FIGS. 3A and 3B by supplying two different metallic source gases to form a thin film containing those two constituent metallic elements of said metallic source gases, and an associated source gas supply system for carrying out the method for forming a thin film containing two constituent metallic elements described previously is shown in FIG. 5C. Likewise, a thin film containing three or four metallic elements can be formed by using an extended process method of a thin film formation.

Referring to FIG. 5A, a reactant purge gas 400 is supplied into a reactor (not shown) during the period of the gas supply cycle T9_{cycle}. After the first source gas 402 is adsorbed onto a substrate (not shown) in said reactor by supplying the first source gas 402 into said reactor (not shown), the supply of the first source gas 402 is stopped and the first source gas 402 not adsorbed onto said substrate but still remaining in said reactor is purged to the outside of said reactor by feeding a reactant purge gas 400 is fed into said reactor. Here, the first source gas 402 contains a constituent element of the thin film to be formed, and does not react with non-activated reactant purge gas 400. Referring to FIG. 5C, the RF power 440 is turned on after purging the first source gas 402 to the outside of said reactor by feeding a reactant purge gas 400 into said reactor. The reactant purge gas 400, activated by a plasma by turning the RF power 440 on, reacts with said first source gas 402 adsorbed onto the surface of a substrate (not shown), thereby a thin film is formed. Next, the RF power 440 is turned off, and then the second source gas 404 is supplied into said reactor so that the second source gas 404 is adsorbed onto the surface of said substrate, and the supply of the second source gas 404 is stopped and a non-reactant purge gas 400 is fed into said reactor in order to purge the un-adsorbed second source gas from said reactor and then eventually to outside of said reactor. Here, the second source gas 404 contains a constituent element of the thin film to be deposited, and said second source gas 404 does not react with said reactant purge gas 400 when not activated by plasma. After the second source gas 404 is purged out to outside of said reactor by feeding said reactant purge gas 400, an RF power 440 is applied to generate plasma in said reactor. The reactant purge gas 400 activated by plasma reacts with the second source gas 404 adsorbed onto the surface of the substrate, and a thin film is formed. Next, the RF power 440 is turned off. FIG. 5A shows that the first source gas 402 and the second source gas 404 are supplied immediately after the RF power 440 is turned off, but alternatively, as shown in FIG. 5B, before supplying the first source gas 402a and the second source gas 404a immediately after the RF power 440a is turned off, an additional step of supplying said reactant purge gas 400a for few milliseconds or up to few hunched milliseconds so that the radicals or radical species generated by plasma disappears, thereby the source gases do not react with the activated reactant purge gas 400a. As afore-described above, referring to FIGS. 5A and 5B, a thin film to a desired thickness is formed by repeating the gas supply cycles T9_{cycle}, T10_{cycle} by intermittently supplying the first source gases 402, 402a and the second source gases 404, 404a into a reactor (not shown) while a reactant purge gas 400, 400a is continuously fed during the gas supply period T9_{cycle}, T10_{cycle}, and also applying an RF power intermittently while the reactant purge gas 400, 400a is fed to said reactor in FIGS. 5A and 5B.

FIG. 5C illustrates a source gas supply system, wherein two metallic source gases containing two different kinds of constituent metallic elements of a thin film to be formed. The explanation of FIG. 5C is not given here, because FIG. 5C is identical to FIG. 3C except that FIG. 5C has only an additional feature of the second gas supply tube 416 and a valve 415 for supplying the second source gas 404, 404a compared to the source gas supply system illustrated in FIG. 3C.

Embodiment 5

The composition of metallic elements in a thin film to be formed may be varied or controlled by using a supercycle T_{supercycle}, by combining simpler gas supply periods T_{cycle}.

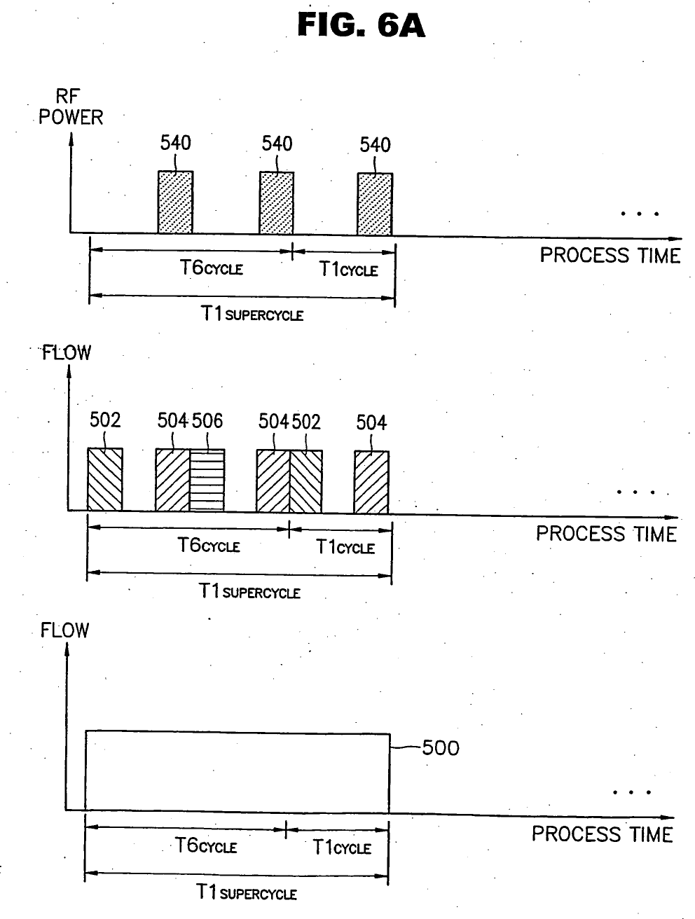

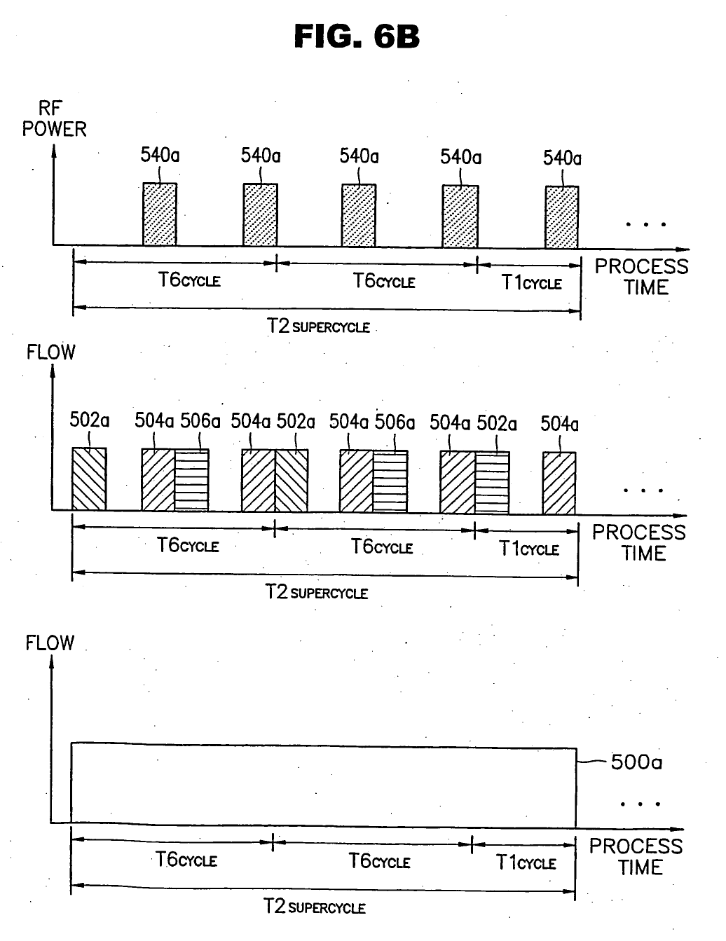

In the following, methods for controlling the composition of a thin film to be formed by repeating a supercycle structured by combining in several different ways the gas supplycycles T1_{cycle}, T6_{cycle}, in FIGS. 2A and 4A, respectively are described. As illustrated in FIGS. 6A and 6B, a thin film containing more volume in metallic constituent element to the first source gas is formed by repeating the supercycle T1_{supercycle} or T2_{supercycle}, in FIG. 6A and FIG. 6B, respectively, which are various combinations of the gas supply cycles T1_{cycle}, T6_{cycle}, in FIGS. 2A and 4A. in comparison with the volume of metallic element, constituent to the first source gas, of a thin film formed by repeating the gas supply cycle T6_{cycle}, in FIG. 4A.

FIG. 6A illustrates a method for forming a thin film, wherein the ratio of metallic elements in the thin film varies, and wherein the thin film is formed by repeating the gas supply cycle T6_{cycle}, in FIG. 4A and the gas supply cycle T1_{cycle} in FIG. 2A, alternately.

Referring to FIG. 6A, a thin film containing more volume in metallic element, constituent to the first source gas, can be formed by alternately repeating the gas supply cycle T6_{cycle}, in FIG. 4A and the gas supply cycle T1_{cycle} in FIG. 2A, in comparison with the volume in metallic element, constituent to the first source gas, of a thin film formed by repeating the gas supply cycle T6_{cycle}, in FIG. 4A. Here, the gas supply supercycle T1_{supercycle} in FIG. 6A is a combination of the gas supply cycle T6_{cycle} in FIG. 4A and the gas supply cycle T1_{cycle} in FIG. 2A, respectively. Plasma 540 is generated in synchronous with the second source gas 504. T6_{cycle} consists of the periods of the first source gas 502, a time gap, the second source gas 504, the third source gas 506, a time gab, and again second source gas 504. The purge gas 500 is supplied. Even though it is not illustrated in the figures, several milliseconds or up to several hundred milliseconds after turning off the plasma during the respective gas supply cycles, i.e., the gas supply cycle T6_{cycle} in FIG. 4A and the gas supply cycle T1_{cycle}, respectively, either the supply of the second source gas is stopped or after the plasma is turned off for several to several hundred milliseconds, a purge gas is fed for several or up to several hundred milliseconds, and one of the additional steps described alone may be added before the step of supplying the source gas.

FIG. 6B illustrates a method for forming a thin film with varying compositions of metallic elements by processing the gas supply cycle T6_{cycle} in FIG. 4a twice, and the gas supply cycle T1_{cycle} in FIG. 2A once and then repeating the afore-mentioned steps a thin film can be formed, wherein the formed thin film contains the constituent element more in volume than thin film formed by repeating the gas supply cycles of T6_{cycle} shown in FIG. 4A.

Here, the gas supply cycle T2_{cycle} is a sum of two times of the gas supply cycle T6_{cycle} in FIG. 4A and the gas supply cycle T1_{cycle} in FIG. 2A. Even though it is not illustrated in a figure, after the RF power is turned off during each gas supply period, i.e., the gas supply cycle T6_{cycle} in FIG. 4A and the gas supply cycle T1_{cycle} in FIG. 2A, a step of either the supply of the second source gas is stopped after a time laps of several or up to several hundred milliseconds, or a purge gas is fed to a reactor for several or up to several hundred milliseconds after the plasma is turned off so that the plasma-activated radical species are removed from the reactor, can be added prior to the step of supplying source gases.

Also, again, even though it is not illustrated in a figure, following the afore-described principles, it is possible to form a thin film containing volume-wise more constituent metallic elements of the first source gas and the second source gas by repeating the gas supply cycle T6_{cycle} in FIG. 4A three times and by processing the gas supply cycle T1_{cycle} in FIG. 2A once compared to the thin film formed by repeating the gas supplycycle T6_{cycle} in FIG. 4A alone. Here, the gas supply period is a super cycle T2_{supercycle} In FIG. 6B, wherein T2_{supercycle} is a sum of three times of the gas supply cycle T6_{cycle} in FIG. 4A and the gas supply cycle T1_{cycle} in FIG. 2A.

Embodiment 6

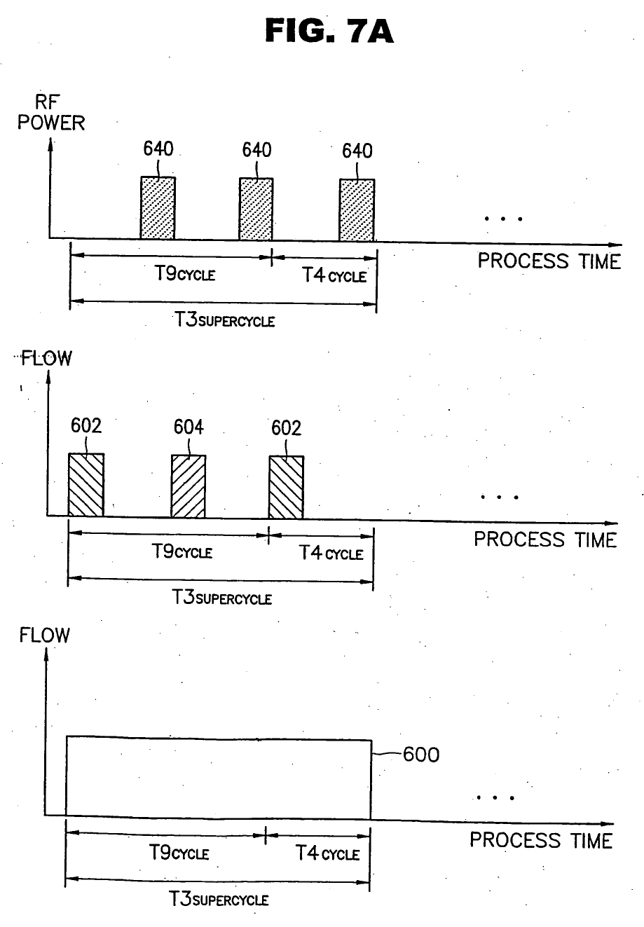

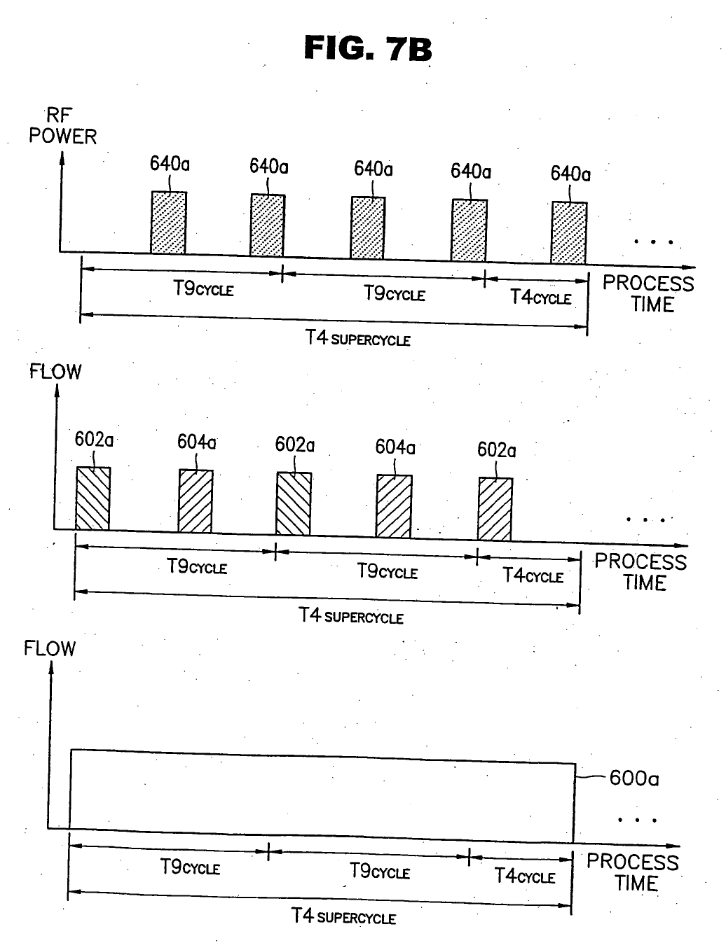

The ratio of the metallic elements of a metallic thin film to be formed can be varied, that is, the composition of a metallic thin film to be formed can be controlled. In other words, a metallic thin film containing volume-wise more metallic element chosen can be formed by repeating the supercycle resulting from a combination of the gas supply cycle T4_{cycle} in FIG. 3A and the gas supply cycle T9_{cycle} in FIG. 5A, compared to a metallic thin film formed by repeating the gas supply cycle T9_{cycle} in FIG. 5A, as illustrated in FIGS. 7A and 7B.

FIG. 7A illustrates a method for forming a thin film with a varying composition of metallic elements desired, by alternately repeating the gas supply cycle T9_{cycle} in FIG. 5A and the gas supply cycle T4_{cycle} in FIG. 3A. Referring to FIG. 7A, a metallic thin film containing volume-wise more constituent metallic element in the first source gas by alternately repeating the gas supply cycle T9_{cycle} in FIG. 5A and the gas supply cycle T4^{cycle} in FIG. 3A. Here, the gas supply cycle T3_{supercycle} is a combination of the gas supply cycle T9_{cycle} in FIG. 5A and the gas supply cycle T4_{cycle} in FIG. 3A, wherein, in FIG. 7A, the first timing diagram shows the on-off periods of an RF power, the second timing diagram shows a gas supply sequence of the first source gas 602 and the second source gas 604, and the third timing diagram shows the timing of the supply of a purge gas 600. Even though it is not shown in the figure, after the RF power is turned off, during each gas supply cycle of T9_{cycle} in FIG. 5A and T4_{cycle} in FIG. 3A, a step of supplying a reactant purge gas for several or up to several hundred milliseconds to the reactor so that the plasma-activated radical species are removed from the reactor, can be added to between the steps of supplying the first source gas and the second source gas.

FIG. 7B is a timing diagram showing a method for forming a metallic thin film with varying metallic content by amount by repeating the steps of processing Twice the gas supply cycle T9_{cycle} in FIG. 5A and of processing the gas supply cycle T4_{cycle} in FIG. 3A once. Again, referring to FIG. 7B, a metallic thin film containing more content by amount of the constituent metallic element in the first source gas 602 can be formed by repeating the steps of processing twice the gas supply cycle T9_{cycle} in FIG. 5A and of processing the gas supply cycle T4_{cycle} in FIG. 3A once. In FIG. 7B, the gas supply cycle is a super cycle T4_{supercycle} which is a sum of twice of the gas supply cycle T9_{cycle} in FIG. 5A and the gas supply cycle T4_{cycle} in FIG. 3A. Even though it is not shown in the figure, after the RF power is turned off, during each gas supply cycle of T9_{cycle} in FIG. 5A and T4_{cycle} in FIG. 3A, a step of supplying a reactant purge gas for several or up to several hundred milliseconds to the reactor so that the plasma-activated radical species are removed form the reactor, can be added to between to steps of supplying the first source gas and the second source gas. Also, again, even though it is not shown in the figure, by using the same principle afore-described, a thin film containing more content by amount of a constituent element of the first source gas can be formed by repeating the steps of processing the gas supply cycle T9_{cycle} in FIG. 5A three times, and of processing the gas supply cycle T4_{cycle} in FIG. 3A once. Here, the resultant gas supply cycle is a supercycle T4_{supercycle} that is a combination of a repeat of three times of the gas supply cycle T9_{cycle} in FIG. 5A and one gas supply cycle T4_{cycle} in FIG. 3A.

Since a thin film of a thickness at an atomic layer level is formed when a minimum cycle or a supercycle is processed, by repeating the supercycle, a sufficiently uniform layer of a thin film can be formed. In case that the uniformity of a thin film formed is not even both in vertical and horizontal directions with respect to the surface of the thin film formed, a better uniformity of the thin film be achieved through a process of heat-treatment.

Embodiment 7

Illustrated in the following are methods forming thin films containing continuously varying content by amount of constituent elements of source gases by repeating a supercycle resulted in by combining source gas cycles of T4_{cycle} in FIG. 3A and T9_{cycle} in FIG. 5A. Each of the source gas supply cycles T9_{cycle} and T4_{cycle} shown FIG. 7A is processed once, that is, the supercycle, T3_{supercycle} is processed once. The source gas cycle T9_{cycle} in FIG. 7b is processed twice and also the source gas cycle T4_{cycle} in FIG. 7B is processed once, that is, the supercycle T4_{supercycle} in FIG. 7B is processed once. Even though not shown in FIG. 7A or FIG. 7B, the source gas cycle T9_{cycle} is processed three times, and afterwards the source gas cycle T4_{cycle} is processed once, wherein the resulting supercycle is called T5_{supercycle} (not shown) and the process described above is equivalent to processing the supercycle T5_{supercycle} once. Likewise another super cycle T6_{cycle} comprising the steps of processing T9_{cycle} four times and processing T4_{cycle} once. Next, each one of the similarly defined gas supply super cycles T7^{supercycle}, T8_{supercycle}, T9_{supercycle} are processed once. As a result, a metallic thin film with varying contents by amount changing from the result obtained by processing T3_{supercycle} to the result obtained by processing T9_{cycle}, can be formed.

As shown in this exemplary embodiment, a thin film with continuously varying contents by amount can be formed by processing a source gas supplycycle m times and by processing another source gas supplycycle n times, and then repeating the combined process cycle, and furthermore, by proceeding above-described processes by choosing integers for m and n instead of fixing them.

Similarly to Embodiment 7 described above, a metallic thin film with continuously varying contents by amount can be, of course, formed by processing the super cycles obtained by combining the gas supply cycles T1_{cycle} and T6_{cycle} in FIGS. 2A and 4A in many different ways.

When the uniformity of a thin film formed is not even both in vertical and horizontal directions respect to the surface of the thin film formed, better uniformity of the thin film can be achieved by going through a process of heat-treatment.

The present invention is described in detail in the above embodiment by giving best modes for carrying out the present invention, however, the principles and ideas of the present invention are not limited to those presented in the embodiments above, and those who are familiar with the art should by able to readily derive many variations and modifications of the principles and ideas of the present invention within the scope of the technical ideas of the present invention presented here.

The methods of forming thin films presented here according to the present invention allows to form thin films even at low temperatures by activating the source gases by plasma, even if the reactivity between the source gases is relatively low. Also, the steps of supplying and discontinuing a purge gas can be omitted thereby the gas supply cycle can be simplified, and as a result the rate of thin formation can be increased. Furthermore, the method presented here allows the operation of an atomic layer deposition apparatus possible even if less number of gas flow control values are used, compared to the alomic layer deposition where only one of a source gas and a purge gas is supplied to a reactor at a given time. In addition, thin films containing a plural of metallic elements such as SrTiO₂ and SrBi₂Ta₂O₅ can be formed according to the present invention, and also thin films containing constituent metallic elements contained in the source gases and their contents by amount can be formed by using supercycles T_{supercycle} comprising combinations of simpler gas supplycycle T_{cycle}, whereby the compositions of the metallic elements contained in the thin films formed can be controlled, and also the compositions can be continuously varied.

1. A method for forming a thin film comprising:
(a) supplying a first source gas to a reactor loaded with a substrate in which reactor a reaction for forming said thin film takes place,
(b) stopping supply of said first source gas and purging said first source gas remaining in said reactor,
(c) supplying a second source gas to said reactor, wherein radio frequency (RF) electric power is applied during the supply period of said second source gas to activate said second source gas, and
(d) turning said RF electric power off and stopping the supply of said second source gas,
wherein a purge gas is continuously supplied while the steps (a) through (d) are processed to form said thin film.

2. The method of claim 1, wherein processing the steps of (a) through (d) are repeated a predetermined number of times.

3. The method of claim 1, further comprising:
purging the activated second source gas remaining in said reactor after the step (d),
wherein said purge gas is supplied continuously while purging the activated second source gas.

4. The method of claim 1, wherein the step (d) comprises the processes of turning the RF electric power off and stopping supply of said second source gas after a predetermined duration of time,
wherein said purge gas is continuously supplied while said second source gas is being supplied after said RF electric power is turned off.

5. The method of claim 1, wherein said first source gas contains a constituent element of a thin film to be formed, and does not react with said purge gas.

6. The method of claim 1, wherein said second source gas contains a constituent element of a thin film to be formed, does not react with said purge gas, and does not react with inactivated first source gas.

7. The method of claim 1, after the step (d) further comprising:
(e) supplying a third source gas to said reactor;
(f) stopping supply of a third source gas and purging said third source gas remaining in said reactor,
(g) supplying said second source gas to said reactor, wherein RF electric power is applied during the supply period of said second source gas so that said second source gas is activated, and
(h) stopping supply of said RF electric power and said second source gas,
wherein said purge gas is continuously supplied while the steps (e) through (h) are processed to form said thin film.

8. The method of claim 7, wherein the steps (a) through (h) are processed m times and the steps (a) through (d) are processed n times and these processes are repeated to form a thin film having a constituent element of said first source gas, wherein said thin film formed contains more constituent element in amount than that in a thin film formed by repeating the steps (a) through (h), and where m and n are natural numbers equal to or larger than 1 and m is larger than n.

9. The method of claim 7, wherein a thin film is formed by processing the steps (a) through (h) m times and processing the steps (a) through (d) n times and the entire process is repeated to form a thin film, thereby the composition of said thin film formed is continuously varied by setting the values of m and n to natural numbers including 0(zero) instead of fixing them.

10. The method of claim 7, wherein each one of the steps of (d) through (h) comprises the step of stopping supply of said second source gas after a predetermined period of time from the time when said RF electric power is turned off, and wherein said purge gas is continuously supplied to said reactor while supplying said second source gas after said RF electric power is turned off.

11. The method of claim 7, further comprising:
purging the activated second source gas remaining in said reactor, after the step (d) and before the step (e), and
purging the activated second source gas remaining in said reactor after the step (h),
wherein said purge gas is continuously supplied while said activated second source gas is being purged.

12. The method of claim 7, wherein a third source gas contains a constituent element of a thin film to be formed, does not react with said purge gas, and does not react with inactivated second source gas.

13. A method for forming a thin film, while supplying a reactant purge gas continuously into a reactor loaded with a substrate, comprising:
(A) supplying a source gas to a reactor loaded with a substrate,
(B) stopping supply of said source gas and purging said source gas remaining in said reactor;
(C) turning on the RF electric power to activate said reactant purge gas; and
(D) turning off said RF electric power,
wherein said reactant purge gas is continuously supplied into said reactor loaded with a substrate, in which reactor a reaction for forming a thin film takes place while processing the steps (A) through (D).

14. The method of claim 13, wherein the steps (A) through (D) are repeated a predetermined number of times.

15. The method of claim 13, further comprising:
purging the activated reactant purge gas remaining in said reactor after the step (D),
wherein said reactant purge gas is continuously supplied into said reactor while said activated reactant purge gas is being purged.

16. The method of claim 13, wherein said source gas contains a constituent element of a thin film to be formed, and does not react with the inactivated reactant purge gas.

17. The method of claim 13, wherein said reactant purge gas contains a constituent element of a thin film to be formed, and does not react with said source gas without plasma, but reacts with the source gas with plasma-assisted activation.

18. The method of claim 13 after the step (D), further comprising:
(E) supplying a second source gas into said reactor loaded with a substrate,
(F) stopping supply of said second source gas and purging said second source gas remaining in said reactor,
(G) turning on the RF electric power to activate said reactant purge gas, and
(H) turning off the RF electric power,
wherein said reactant purge gas is continuously supplied into said reactor while the steps (E) through (H) are being processed.

19. The method of claim 18, wherein the steps (A) through (H) are processed m times and the steps (A) through (D) are processed m times, and then both processes are repeated to form a thin film containing a constituent element of said first source gas more content by amount than that in a thin film formed by repeating the steps (A) through (H), wherein m and n are natural numbers equal to or greater than 1 and m is greater than n.

20. The method of claim 18, wherein the steps (A) through (H) are processed m times, and the steps (A) through (D) n times and then both processes are repeated to form a thin film in such a way that the composition of said thin film formed is gradually and continuously changed by varying the numbers of repetitions m and n from zero(0) to natural numbers.

21. The method of claim 18 further comprising:
purging said activated reactant purge gas remaining in said reactor after the step (d), and
purging the activated reactant purge gas remaining in said reactor after the step (H),
wherein said reactant purge gas is continuously supplied into said reactor while said activated reactant purge gas is being purge.

22. The method of claim 18, wherein said second source gas contains a constituent element of a thin film to be formed, and does not react with said inactivated reactant purge gas.
